(19) United States
(12) Patent Application Publication
(10) Pub. No.: US 2008/0252814 A1
(43) Pub. Date: Oct. 16, 2008

(54) OPTICAL ELEMENTS COVERING MEMBER, BACKLIGHT AND LIQUID CRYSTAL DISPLAY DEVICE

(75) Inventors: Taro Omura, Miyagi (JP); Eiji Ohta, Miyagi (JP); Shogo Shinkai, Miyagi (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/099,637

(22) Filed: Apr. 8, 2008

(30) Foreign Application Priority Data
Apr. 10, 2007 (JP) 2007-103347

(51) Int. Cl. G02F 1/1335; B32B 3/02; G02F 1/03

(52) U.S. Cl. 349/62; 428/76; 359/253

(57) ABSTRACT

A optical element covering member includes one or more optical elements, a support medium for supporting the one or more optical elements, and a cover material for covering the one or more optical elements and the support medium. The cover material includes a layer of block copolymer of vinyl aromatic hydrocarbon and conjugate diene, and a mass ratio of the vinyl aromatic hydrocarbon to the conjugate diene stands at 95:5 to 5:95.

### CROSS REFERENCE TO RELATED APPLICATIONS

The present application claims priority to Japanese Patent Application No. 2007-103347 filed in the Japanese Patent Office on Apr. 10, 2007, the entire content of which is being incorporated herein by reference.

### BACKGROUND

The present application relates to a cover structure of optical element, a backlight having the cover structure of optical element, and a liquid crystal display device. More particularly, the present application relates to a cover structure of optical element for improving display characteristics of a liquid crystal display device.

Many optical elements have been used in a liquid crystal display device in order to improve an angle of visibility, a luminance and the like. These optical elements have film shapes or sheet shapes such as a diffusion film and a prism sheet.

FIG. 10 shows the structure of a related art liquid crystal display device. As shown in FIG. 10, this liquid crystal display device includes a illuminating device 101 for emitting light, a diffusion plate 102 for diffusing light emitted from the illuminating device 101, a plurality of optical elements 103 for converging or diffusing light diffused by the diffusion plate 102, and a liquid crystal display panel 104.

There is a tendency that the weight and size of each optical element become large because of recent large scale image display devices. As the weight and size of each optical element increase, deformation of each optical element may occur due to insufficient rigidity of the optical element. This deformation of the optical element adversely affects an optical directivity relative to a display surface, posing a serious issue of irregular luminance.

It has therefore been proposed to improve insufficient rigidity of an optical element by increasing the thickness of each optical element. However, an increased thickness makes a liquid crystal display device thick, whereby the advantages that a liquid crystal display device is thin and light will be lost. It has therefore been proposed to improve insufficient rigidity of a sheet or film like optical element by adhering optical elements with transparent pressure sensitive adhesive (refer for example to Japanese Patent Unexamined Publication No. 2005-301147, Patent Document 1).

With the technology described in Patent Document 1, however, a liquid crystal display device itself becomes thick because optical elements are adhered with transparent pressure sensitive adhesive, although a thickness increase is not so large as that of the improving method of each optical element. There is a possibility that the transparent adhesive may degrade the display characteristics of a liquid crystal display device.

### SUMMARY

According to an embodiment, there are provided a cover structure of optical element, a backlight having the cover structure of optical element, and a liquid crystal display device capable of improving insufficient rigidity of an optical element while suppressing an increase in the thickness of the liquid crystal display device or a degradation of display characteristics of the liquid crystal display device.

The present inventors have studied to improve insufficient rigidity of an optical element while suppressing an increase in the thickness of the liquid crystal display device or a degradation of display characteristics of the liquid crystal display device, and have invented a cover structure of optical element for covering an optical element and a support member with a cover as described in the present application.

The cover material used for the cover structure of optical element is made of material such as a film having a heat shrinkage characteristic so that adhesion between an optical element and the cover can be enhanced.

A related art heat shrinkage film used as a shrinkage package of a container has the characteristics that (1) the film has transparency, (2) the film is hard to cause curl by application of heat ranging from an ordinary temperature to 85° C. and has good shrinkage characteristics (3) the film can pack the container in tight adhesion, and has less natural shrinkage. The material of a heat shrinkage film having the characteristics may be, for example, polyolefin resin such as polyethylene (PE) and polypropylene (PP), polyester resin such as polyethyleneterephthalate (PET) and polyethylenenaphthalate (PEN), vinyl bond resin such as polystyrene (PS) and polyvinyl alcohol (PVA), polycarbonate (PC) resin, cycloolefin resin, and vinyl chloride resin. Each or a mixture of these materials is used.

The cover structure of an embodiment is required to have a function superior to that of a related art package, because the cover is assembled to a backlight unit of a liquid crystal television set. Namely, it is necessary to reduce a loss of light from a light source as much as possible. A price reduction is strongly requested for recent liquid crystal television sets, therefore an expensive film of cycloolefin resin cannot be used although this film presents excellent performance. Further, although a large amount of vinyl chloride resin are currently used as package material, there is a tendency that use of vinyl chloride resin will be suppressed further from the viewpoint of global environment protection.

The present inventors have researched heat shrinkage film material capable of suppressing a loss of light from a light source as much as possible and adaptable to optical members according to an embodiment.

The research has found the cover including a layer having block copolymer of vinyl aromatic hydrocarbon and conjugate diene, in which a mass ratio of the vinyl aromatic hydrocarbon to the conjugate diene is 95:5 to 5:95 which is a basis of the present application.

In an embodiment, an optical element covering member includes one or more optical elements, a support medium for supporting the one or more optical elements, and a cover structure for covering the one or more optical elements and the support medium. The cover includes a layer having block copolymer of vinyl aromatic hydrocarbon and conjugate diene, and a mass ratio of the vinyl aromatic hydrocarbon to the conjugate diene is 95:5 to 5:95.

In another embodiment, a backlight includes a light source for emitting light and a optical element covering member for improving characteristics of light emitted from the light source and outputting light to a liquid crystal panel. The optical element covering member includes one or more optical elements, a support medium for supporting the one or more optical elements, and a cover for covering the one or more optical elements and the support medium. The cover includes a layer of block copolymer of vinyl aromatic hydrocarbon and conjugate diene and a mass ratio of the vinyl aromatic hydrocarbon to the conjugate diene is 95:5 to 5:95.

In yet another embodiment, a liquid crystal display device includes a light source for emitting light and a optical element covering member for improving characteristics of light emitted from the light source and outputting light to a liquid crystal panel. The optical element covering member includes one or more optical elements, a support medium for supporting the one or more optical elements, and a cover for covering the one or more optical elements and the support. The cover includes a layer having block copolymer of vinyl aromatic hydrocarbon and conjugate diene and a mass ratio of the vinyl aromatic hydrocarbon to the conjugate diene stands at 95:5 to 5:95.

According to an embodiment, since the cover material covers one or more optical elements and support medium, the one or more optical elements and support medium can be formed integrally. It is therefore possible to cover insufficient rigidity of the optical elements by support medium.

According to an embodiment, the cover material contains block copolymer of vinyl aromatic hydrocarbon and conjugate diene, and a mass ratio of the vinyl aromatic hydrocarbon to the conjugate diene stands at 95:5 to 5:95. It is therefore possible to suppress degradation of optical characteristics by the cover material.

Additional features and advantages are described herein, and will be apparent from the following Detailed Description and the figures.

### BRIEF DESCRIPTION OF THE FIGURES

FIG. 1 is a schematic diagram showing an example of the structure of a liquid crystal display device according to a first embodiment;

FIG. 2 is a perspective view showing an example of a first structure of a optical element covering member according to the first embodiment;

FIG. 3 is a cross sectional view showing a first example of a bonding portion of a cover material according to the first embodiment;

FIG. 4 is a cross sectional view showing a second example of a bonding portion of a cover material according to the first embodiment;

FIG. 5 is a perspective view showing an example of a second structure of the optical element covering member according to the first embodiment;

FIG. 6 is a perspective view showing an example of a third structure of the optical element covering member according to the first embodiment;

FIG. 7 is a perspective view illustrating an example of a manufacture method of the optical element covering member according to the first embodiment;

FIG. 8 is a perspective view showing an example of a structure of a backlight according to a second embodiment;

FIG. 9 is a perspective view showing an example of a structure of a backlight according to a third embodiment; and

FIG. 10 is a schematic diagram showing the structure of a related art liquid crystal display device.

### DETAILED DESCRIPTION

Embodiments will be described with reference to the accompanying drawings.

### (1) First Embodiment

(1-1) Structure of Liquid Crystal Display Device

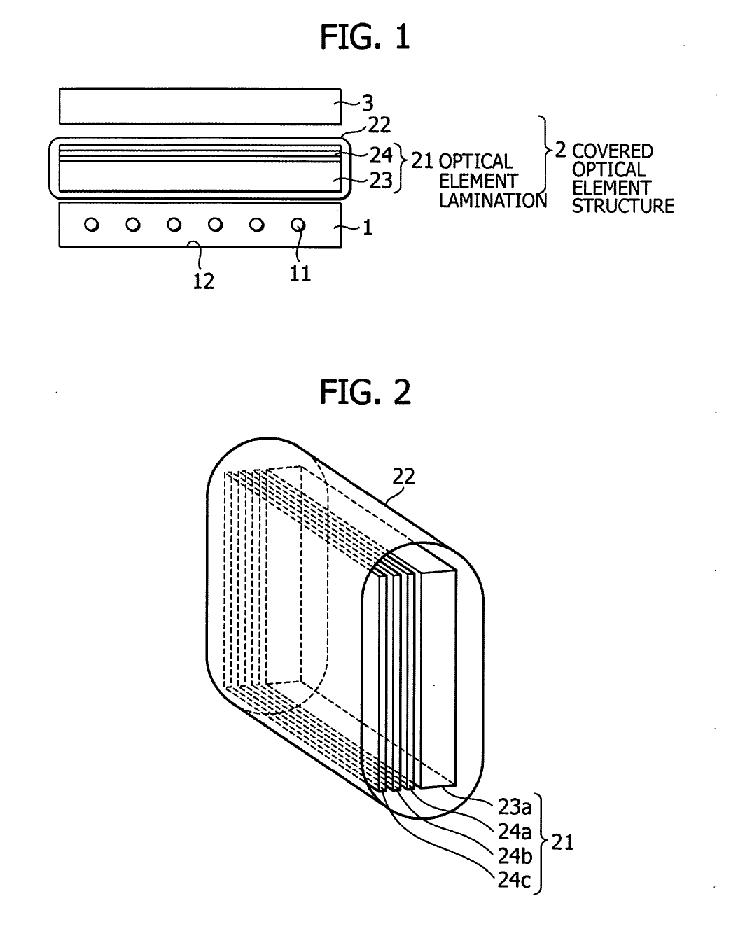

FIG. 1 shows an example of the structure of a liquid crystal display device according to the first embodiment. As shown in FIG. 1, the liquid crystal display device includes an illuminating device 1 for emitting light, a optical element covering member 2 for improving characteristics of light emitted from the illuminating device 1, and a liquid crystal panel 3 for displaying an image in accordance with light whose characteristics are improved by the optical element covering member 2. A backlight is constituted of the illuminating device 1 and optical element covering member 2. In the following, a plane upon which light from the illuminating device 1 becomes incident is called an incident surface, a plane from which light entered from the incident surface is output is called an transmission surface, and planes positioned between the input and transmission surfaces are called end planes. The input and transmission surfaces are collectively called a principal plane where applicable.

The illuminating device 1 is, for example, a just-under type illuminating device, and has a light source 11 for emitting light and a reflective plate 12 for reflecting light emitted from the light source 11 and directing the light toward the liquid crystal panel 3. A cold cathode fluorescent lamp (CCFL), a hot cathode fluorescent lamp (HCFL), an organic electro luminescence (OEL) or a light emitting diode (LED) may be used for the light source 11. The reflective plate 12 is placed such that it covers the lower portions and side portions of one or more light sources 11, and reflects light emitted to the bottoms and sides from the one or more light sources 11 to direct the light toward the liquid crystal panel 3.

The optical element covering member 2 includes, for example, one or more optical elements 24 for changing characteristics of light emitted from the illuminating device 1 by executing processes such as light diffusion and convergence, a support medium 23 for supporting the one or more optical elements, and a cover material 22 for covering and integrating the one or more optical elements 24 and support medium 23. In the following, the support medium 23 and one or more optical elements layered together are called an optical element lamination 21.

The number and type of optical elements 24 are not specifically limited, but the number and type may be properly selected in accordance with characteristics of a desired liquid crystal display device. The optical element 24 may be constituted of the support medium 23 and one or more functional layers, or only one or more functional layers. For example, the optical element 24 may be an optical diffusion element, an optical convergence element, a reflection type polarizer, a polarizer, an optical division element or the like. The optical element 24 may be a film, a sheet or a plate type. A thickness of the optical element 24 is, e.g., 5 to 1000 μm.

The support medium 23 is, for example, a transparent plate for transmitting light emitted from the illuminating device 1, or an optical plate for changing characteristics of light emitted from the illuminating device 1 by executing processes such as diffusion and convergence of light. The optical plate may be a diffusion plate, a phase difference plate or a prism plate. A thickness of the support medium 23 is, e.g., 1000 to 50000 μm. For example, the support medium 23 is preferably made of high polymer materials and has a transmissivity of 30% or higher. The lamination order between the optical element 24 and support medium 23 is selected in accordance with the functions of the optical element 24 and support medium 23. For example, if the support medium 23 is a diffusion plate, the support medium 23 is positioned on the side where light is input from the illuminating device. If the support 23 is a reflection type polarizer plate, the support 23 is positioned on the side where light is emitted to the liquid crystal panel 3. The shapes of the input and transmission surfaces of the optical element 24 and support medium 23 are selected in accordance with the shape of the liquid crystal panel 3, and are a rectangle shape with a different vertical/horizontal ratio (aspect ratio).

It is preferable to perform concave/convex processing to the principal planes of the optical element 24 and support medium 23 or make the plane contain fine particles to reduce rubbing and friction. When necessary, the optical element 24 and support medium 23 may contain additive agent such as light stabilizer, ultraviolet absorber, antistatic agent, fire retardant and antioxidant, to provide a ultraviolet absorption function, an infrared absorption function, an electrostatic suppression function and the like to the optical element 24 and support medium 23. Further, the optical element 24 and support medium 23 may be subject to surface treatment such as an antireflection process (AR process) and an antiglare process (AG process) to reduce diffusion of reflected light and reflected light itself. The surfaces of the optical element 24 and support medium 23 may have a function of reflecting ultraviolet and infrared rays.

The cover material 22 is, for example, a film, a sheet or a sack type of a transparent single layer or a plurality of transparent layers. The cover material 22 has, for example, a sheet shape, and opposite end portions thereof in the longitudinal direction are bonded preferably on an end section of the optical element lamination 21, or the cover material 22 has a tubular shape with no bonding portions. In the following, the surface of the cover material 22 on the side of the optical element lamination 21 is called an inner surface, and the surface on the opposite side is called an outer surface.

If a principal plane of the optical element lamination 21 has a rectangular shape with a different vertical/horizontal ratio (aspect ratio), the cover material 22 covers the principal plane and opposite end planes connected to the longer sides of the principal plane, while opposite end planes connected to the shorter sides of the principal plane are exposed from the cover material 22, or the cover material 22 covers the principal plane and opposite end planes connected to the shorter sides of the principal plane while the opposite end planes connected to the longer sides of the principal plane are exposed.

A thickness of the cover material 22 is set to be, for example, 5 to 5000 μm, preferably 10 to 500 μm, and more preferably to 30 to 300 μm. A thickness of the cover material 22 may set to be different at the incident surface side and the transmission surface side. In this case, a thickness on the incident surface side is preferably set to be thicker than that on the transmission surface side. This is because a morphology change in the support medium 23 and optical elements 24 caused by heat emanated from the light source 11 may be suppressed by thickening the cover material on the incident surface side. It is also preferable that the cover material 22 covers the principal planes of the optical element lamination 21 at an area ratio of 50% or more. The cover material 22 may contain a surface structured member as a supporting medium.

If the cover material 22 has anisotropy, this optical anisotropy is preferably made small. Specifically, retardation is preferably 50 nm or shorter, and more preferably 20 nm or shorter. It is preferable to use a sheet or film of uniaxial or biaxial drawing as the cover material 22. If this sheet or film is used, the cover material 22 can be shrunk in the drawing direction by applying heat, whereby tight adhesion between the cover material 22 and optical element lamination 21 can be enhanced.

The cover material 22 is made of a film or sheet of a single layer or a plurality of layers having heat shrinkage characteristic. The cover material 22 includes at least a layer of block copolymer of vinyl aromatic hydrocarbon and conjugate diene. If the cover material 22 is made of a plurality of layers, at least one layer out of the plurality of layers contains at least block copolymer of vinyl aromatic hydrocarbon and conjugate diene.

Vinyl aromatic hydrocarbon in the block copolymer used in the present application may be styrene, o-methylstyrene, p-methylstyrene, 2,4-dimethylstyrene, 2,5-dimethylstyrene, α-methylstyrene, vinylnaphtalane, vinylanthracene or the like. Sthyrene is generally used.

Conjugate diene in the block copolymer used in the present application may be 2,3-butadiene, 2-methyl-1,3-butadiene (isopropylene), 2,3-dimethyl-1,3-butadiene, 1,3-pentadiene or the like. 1,3-butadiene and isopropylene are generally used.

A mass ratio [(vinyl aromatic hydrocarbon):(conjugate diene)] of vinyl aromatic hydrocarbon to conjugate diene stands at 95:5 to 5:95, and preferably 90:10 to 60:40. This is because if a mass ratio of vinyl aromatic hydrocarbon is smaller than 5 mass %, a film rigidity is lowered, whereas if the mass ratio exceeds 95 mass %, surface characteristics are degraded

A block rate of vinyl aromatic hydrocarbon and conjugate diene is preferably 70 to 90 mass %. This is because if the block rate is less than 70 mass %, film synthesis is lowered, whereas if the block rate exceeds 90 mass %, surface is degraded, leaving a fear of unsuitable for practical use. A block rate of vinyl aromatic hydrocarbon is represented by (W1/W0)×100 where W1 is a mass of block polymerization chains of vinyl aromatic hydrocarbon in the copolymer, and W0 is a total mass of vinyl aromatic hydrocarbon in the block copolymer. For example, W1 can be obtained in the following manner. Block copolymer is ozone-decomposed, components of vinyl aromatic hydrocarbon polymer are measured by gel permeation chromatography, a molecular weight corresponding to the chromatogram is obtained by using a calibration curve formed by using standard polystyrene and styrene oligomer, and components having a number average molecular weight over 3000 are obtained through quantitative determination using a peak area. A ultraviolet spectroscopic detector set to a wavelength of 254 nm may be used.

A molecular weight of the block copolymer is 5000 to 500000, and preferably 50000 to 300000. If the molecular weight is smaller than 5000, desired rigidity and heat resistance are difficult to be obtained. If the molecular weight exceeds 500000, mold working becomes difficult. Since working, such as a T die and inflation is bad, the film surface becomes rough, whereby transparency is hard to be obtained.

It is preferable that a heat shrinkage film used for a single layer or a plurality of layers of the cover material 22 further includes vinyl aromatic hydrocarbon polymer. This is because heat resistance, rigidity and adhesiveness with the optical elements 24 may be adjusted by the material characteristics of the optical elements 24 and the structure of the illuminating device 1. Vinyl aromatic hydrocarbon polymer used in the first embodiment is at least one type of polymer selected from a group consisting of (a) vinyl aromatic hydrocarbon polymer, (b) copolymer of vinyl aromatic hydrocarbon and (meta) acrylic acid, (c) copolymer of vinyl aromatic hydrocarbon and (meta) acrylic acid ester, and (d) rubber denatured styrene polymer.

(a) Vinyl aromatic hydrocarbon polymer may be a single polymer or copolymer of two or more polymers of the vinyl aromatic hydrocarbon polymer. Polystyrene is generally used.

(b) Copolymer of vinyl aromatic hydrocarbon and (meta) acrylic acid is obtained by polymerizing, for example, the vinyl aromatic hydrocarbon polymer and (meta) acrylic acid. One or more types monomers may be used for polymerization. (Meta) acrylic acid may be acrylic acid, methacrylic acid and the like.

(c) Copolymer of vinyl aromatic hydrocarbon and (meta) acrylic acid ester can be obtained by polymerizing, for example, the vinyl aromatic hydrocarbon polymer and (meta) acrylic acid ester. One or more types of monomers may be used for polymerization. (Meta) acrylic acid ester may be methyl acrylic acid, ethyl acrylic acid, butyl acrylic acid, methyl methacrylic acid, ethyl methacrylic acid, butyl methacrylic acid and the like.

Copolymer (b) or (c) can be obtained by polymerizing monomer mixture in which mass ratio of vinyl aromatic hydrocarbon with (meta) acrylic acid, or vinyl aromatic hydrocarbon with (meta) acrylic acid ester, respectively are preferably 5:95 to 99:1 and more preferably 70:30 to 99:1.

(d) Rubber denatured styrene polymer can be obtained by polymerizing, for example, a mixture of vinyl aromatic hydrocarbon or monomer capable of being copolymerized with vinyl aromatic hydrocarbon, and various types of elastomer. Vinyl aromatic hydrocarbon polymer described in the block copolymer is used as the vinyl aromatic hydrocarbon polymer, and monomer capable of being copolymerized with vinyl aromatic hydrocarbon polymer may be (meta) acrylic acid, (meta) acrylic acid ester, acrylonitrile and the like. Elastomer may be butadiene rubber, styrene-butadiene rubber, chloroprene rubber or the like. High impact rubber denatured styrene resin (HIPS) is preferably used.

In an embodiment, if block copolymer and vinyl aromatic hydrocarbon polymer are blended, a mass ratio of block copolymer:vinyl aromatic hydrocarbon polymer is preferably 100:0 to 50:50. This is because if the block copolymer is lower than 50 mass %, film heat shrinkage becomes insufficient.

If the film used in the first embodiment is made of a plurality of film layers (multilayer), at least one layer includes components of block copolymer or block copolymer and vinyl aromatic hydrocarbon polymer. Resin used in other layers not including block copolymer or block copolymer and vinyl aromatic hydrocarbon polymer is not specifically limited. However, styrene polymer may be preferably used. Styrene polymer may be styrene-butadiene block copolymer, such as one described in vinyl aromatic hydrocarbon, the vinyl aromatic hydrocarbon polymer, ABS resin, styrene-acrylonitrile copolymer and the like. These resins or polymers may be used singularly or in combination. It is preferable to use styrene-butadiene block copolymer different from the styrene-butadiene block copolymer used in at least one layer containing components of block copolymer, or the vinyl aromatic hydrocarbon polymer.

Since the cover material 22 has at least a layer containing block copolymer of vinyl aromatic hydrocarbon and conjugate diene, a loss of light from the light source can be reduced as much as possible. Higher transparency and lower birefringence than those of a related art film can therefore be obtained. Further, the optical element lamination including the optical elements 24 and support medium 23 and the like to be covered by the cover material can have high adhesiveness to prevent irregular luminance caused by a bent film. Further natural shrinkage can be reduced. Since the cover material has heat resistance characteristic, it is possible to prevent a curl from being formed even under high temperature use environment.

A heat shrinkage rate of the cover material 22 is required to consider the size and material of the support medium 23 and optical elements 24 to be covered and use environment of the optical element lamination 21. At 90° C., the heat shrinkage rate is preferably 0.2% to 100%, more preferably 0.5% to 20%, furthermore preferably in the range from 1% to 10%. If the shrinkage rate is less than 0.2%, there is a fear of poor adhesiveness between the cover material and optical elements, whereas if the shrinkage rate exceeds 100%, heat shrinkage characteristic becomes irregular in a plane and there is a fear of shrinking the optical elements. A thermal deformation temperature of the cover material 22 is preferably 90° C. or higher. This is because it is possible to suppress degradation of the optical characteristics of the optical element covering member 2 caused by heat emanated from the light source 11. A dry reduction amount of material of the cover 22 is preferably 2% or less. A thermal expansion coefficient of the cover material 22 is preferably smaller than that of the support medium 23 and optical elements 24 covered with the cover material 22. This is because tight adhesion can be enhanced between the cover material 22 and optical element lamination 21. A refractive index of material of the cover material 22 (refractive index of the cover material 22) is preferably 1.6 or less and more preferably 1.55 or less.

Preferably, the cover material 22 contains one or more types of fillers. At least one type of organic or inorganic filler may be used. The organic filler may use one or more types of materials selected from a group consisting of, for example, acrylic resin, styrene resin, fluorine and voids. The inorganic filler may use one or more types of materials selected from a group consisting of, for example, silica, alumina, talc, titanium oxide and barium sulfate. The shape of a filler may vary, such as a needle shape, a spherical shape, an ellipsoidal shape, a plate shape, and a flaky shape. A diameter of a filler may select one or more types.

When necessary, the cover material 22 may contain additive agent such as optical stabilizer, ultraviolet absorber, anti-static agent, fire retarding agent and antioxidant to have an ultraviolet absorption function, an infrared absorption function, an electrostatic suppression function and the like. Further, the cover material 22 may be subject to surface treatment such as an antiglare process (AG process) and an antireflection process (AR process) to reduce diffusion of reflected light and reflected light itself. A function of transmitting light in a particular wavelength range such as UV-A light (about 315 to 400 nm) may be provided.

The liquid crystal panel 3 displays information by controlling light supplied from the light source 11. The operation mode of the liquid crystal panel 3 may be a twisted nematic (TN) mode, a vertically aligned (VA) mode, an in-plane switching (IPS) mode or an optically compensated birefringence (OCB) mode.

Next, with reference to FIGS. 2 to 4, examples of the structure of the optical element covering member 2 will be described in detail.

FIG. 2 shows an example of a first structure of the optical element covering member according to the first embodiment. As shown in FIG. 2, the optical element covering member 2 includes, for example, a diffusion plate 23a serving as a support medium, optical elements including a diffusion film 24a, a lens film 24b and a reflection type polarizer 24c, and a cover material 22 for covering and integrating the elements. In this example, the optical element lamination 21 includes the diffusion plate 23a, diffusion film 24a, lens film 24b and reflection type polarizer 24c. The principal planes of the optical element lamination 21 have a rectangle shape having an aspect ratio not indicating a square. The strip cover material 22 covers the principal planes of the optical element lamination 21 and opposite end planes connected to the longer sides of the principal planes, while opposite end planes connected to the shorter side are exposed. Opposite end portions of the strip cover material 22 in the longitudinal direction are bonded together, for example, on the end plane of the optical element lamination 21 on the side of the longer side.

The diffusion plate 23a is mounted above one or more light sources 11 and makes a luminance uniform by diffusing light emitted from one or more light sources 11 and light reflected by the reflection plate 12. The diffusion plate 23a may be a plate having an irregular surface structured member on the surface thereof to diffuse light, a plate containing fine particles having a refractive index different from that of the main constituent material of the diffusion plate 23a, a plate containing void-like fine particles, or a plate having two or more types of the irregular surface structured member, fine particles and void-like fine particles. Fine particles may be made of at least one type of an organic filler and an inorganic filler. The irregular surface structured member, fine particles and void-like fine particles are formed, for example, on the transmission surface of the diffusion plate 24a. An optical transmissivity of the diffusion plate 23a is, for example, 30% or higher.

The diffusion film 24a is mounted on the diffusion plate 23a, and diffuses light diffused by the diffusion plate. The diffusion film 24a may be a film having an irregular surface structured member on the surface thereof to diffuse light, a film containing fine particles having a different refractive index from that of the main constituent material of the diffusion film 24a, a film containing void-like fine particles, or a film having two or more of the irregular surface structured member, fine particles and void-like fine particles. Fine particles may be made of at least one type of an organic filler and an inorganic filler. The irregular surface structured member, fine particles and void-like fine particles are formed, for example, on the transmission surface of the diffusion film 24a.

The lens film 24b is mounted above the diffusion film 24a, and improves a directivity or the like of illumination light. On the transmission surface of the lens film 24b, for example, fine prism lens columns are provided. The cross section of the prism lens along the column direction has, for example, generally an approximately triangle shape whose apex is preferably rounded. This is because a cutoff and a wide view angle can be improved.

The diffusion film 24a and lens film 24b are made of, e.g., polymeric material, and have a refractive index of, e.g., 1.5 to 1.6. The material of the optical elements 24 and optical functional layers provided to the optical elements are preferably photosensitive resin to be cured by light or electron beams, or thermosetting resin to be cured by heat, and most preferably ultraviolet cure resin to be cured by ultraviolet rays.

The reflection type polarizer 24c is mounted on the lens film 24b, passes only one of perpendicular polarization components out of light whose directivity is heightened by the lens sheet, and reflects the other.

The reflection type polarizer 24c is lamination of an organic multilayer film, an inorganic multilayer film, a liquid crystal multilayer film and the like. The reflection type polarizer 24c may contain material having a different refractive index. The reflection polarizer 24c may be provided with a diffusion, lens.

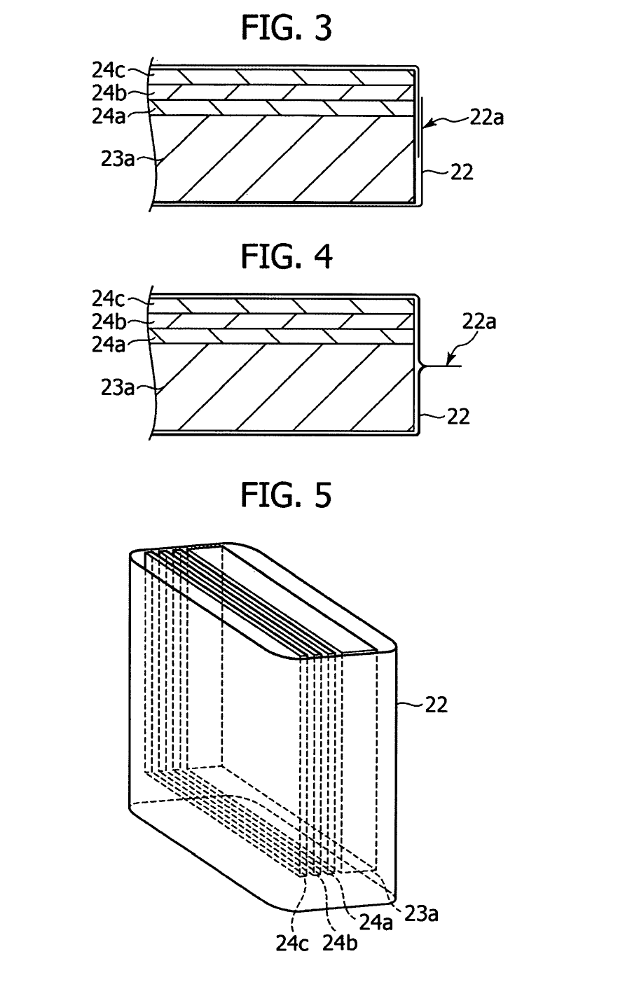

With reference to FIGS. 3 and 4, examples of the bonding portion of the cover material 22 will be described. FIG. 3 shows a first example of the bonding portion of the cover material. As shown in FIG. 3 of the first example, the inner and outer surfaces of the opposite end portions of the cover material are superposed and bonded together on the end planes of the optical element lamination 21. Namely, end portions of the cover material 22 are bonded in conformity with the end planes of the optical element lamination 21.

FIG. 4 shows a second example of the bonding portion of the cover material. As shown in FIG. 4 of the second example, the inner surfaces of the cover material end portions are superimposed and bonded together on the end planes of the optical element lamination 21. Namely, the end portions of the cover material 22 are bonded such that it rises from the end planes of the optical element lamination 21.

FIG. 5 shows an example of a second structure of the optical element covering member according to the first embodiment. As shown in FIG. 5, a strip cover material 22 covers the input and transmission surfaces of the optical element lamination 21 and both side planes connected to the shorter sides of the input and transmission surfaces, while opposite side planes of connected to the longer sides of the optical element lamination 21 are exposed. Opposite end portions of the strip cover material 22 in the longitudinal direction are bonded together on the side plane of the optical element lamination 21 on the longer side.

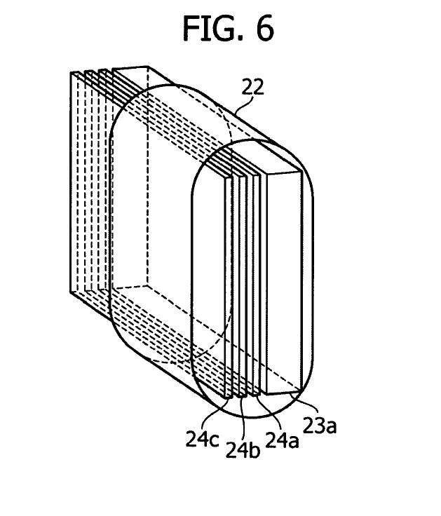

FIG. 6 shows an example of a third structure of the optical element covering member according to the first embodiment. As shown in FIG. 6, a strip cover material 22 covers the central area and nearby area of the optical element lamination 21, while opposite end portions of the optical element lamination 21 on the shorter side are exposed. Opposite end portions of the strip cover material 22 in the longitudinal direction are bonded together on the side plane of the optical element lamination 21 on the longer side.

(1-3) Manufacture Method of Optical Element Covering Member

Next, description will be made on an example of a manufacture method of the optical element covering member having the structure.

[Manufacture Process for Block Copolymer]

First, description will be made on an example of the manufacture processes of block copolymer used in the first embodiment. Block copolymer is obtained by polymerizing vinyl aromatic hydrocarbon and conjugate diene in organic solvent, by using organic lithium compound as initiator. Vinyl aromatic hydrocarbon and conjugate diene used in the present application may use those materials described above, and polymerization can be performed by selecting one or more materials. In living anion polymerization using organic lithium compound as initiator, almost the whole amount of vinyl aromatic hydrocarbon and conjugate diene used for the polymerization reaction is changed to polymer.

If the cover material 22 containing vinyl aromatic hydrocarbon polymer is used, block copolymer and vinyl aromatic hydrocarbon are mixed. A mixture method of block copolymer and vinyl aromatic hydrocarbon is not specifically limited, but blending may be made with a Henschel mixer or a ribbon blender, or mixture may be melted by an extruder to form pellets.

[Manufacture Process of Cover Material]

Next, description will be made on an example of a manufacture process for the cover material 22 used in the first embodiment. In the manufacture method for the cover material 22 of the first embodiment, a single layer film is manufactured, for example, by using a single extruder and then a die, a feed block and the like. A multilayer film is manufactured, for example, by melting the resin material for each layer by each extruder and forming multilayer film from the melted resin by using a die, a feed block and the like. After the film is formed, the film is drawn uniaxially, biaxially or multi-axially, or the film is not drawn. The die may be a well-known T die, ring die and the like. A drawing method may be a method of drawing an extruded film in a direction perpendicular to the extrusion direction and/or in the extrusion direction, by a tenter method. The drawing method may also be a method of drawing a tubular film extruded by a tubular method in a circumferential direction or an extrusion direction.

In an embodiment, a drawing temperature is preferably 60 to 120° C. This is because a film is broken during drawing if the drawing temperature is lower than 60° C., and good shrinkage cannot be obtained if the drawing temperature exceeds 120° C.

A drawing magnification rate is not specifically limited, but preferable be 1 to 8 times. Even at a rate of 1, i.e., even if intentional drawing is not performed, desired shrinkage may be obtained because of shearing of an extruder. If a rate exceeds over 8 times, irregular thickness of a film is likely to occur because of difficult drawing.

[Covering Process for Optical Element Lamination]

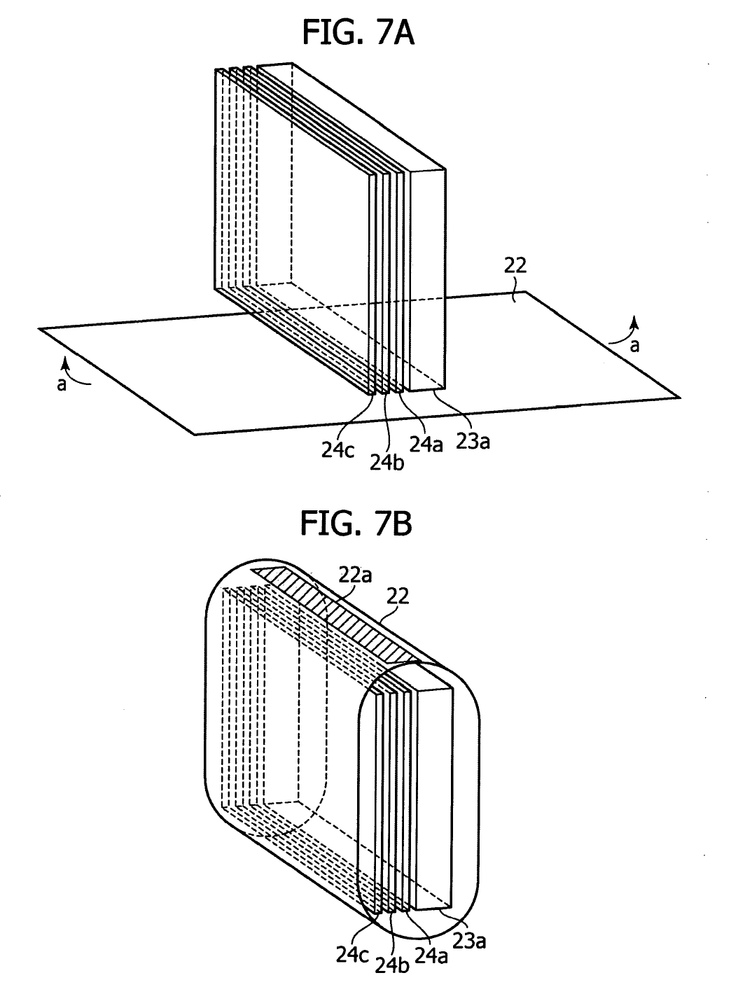

Next, as shown in FIG. 7A, one or more superimposed optical elements 24 and support medium 23 are placed on the strip shaped cover material 22. Next, as indicated by an arrow “a” in FIG. 7A, opposite end portions of the strip cover material 22 in the longitudinal direction are lifted and one or more superimposed optical elements 24 and support medium 23 are covered by the cover material 22. Next, as shown in FIG. 7B, for example, opposite ends of the cover material 22 in the longitudinal direction are bonded on the side plane of one or more optical elements 24 or support medium 23. A bonding method may be adhesion with adhesive or melting. The bonding method with adhesive may be a hot melt bonding method, a thermosetting bonding method, a pressure sensitive (adhesion) bonding method, an energy beam curing bonding method, a hydration bonding method, and the like. The bonding method with melting may be thermal melting, ultrasonic melting, laser melting or the like. Thereafter, when necessary, heat may be applied to the cover material 22 to thermally shrink the cover material 22.

In another example of the manufacture method for the optical element covering member 2, one or more superimposed optical elements 24 and support medium 23 are inserted into a tubular cover material 22. Thereafter, when necessary, heat is applied to the cover material 22 to thermally shrink the cover material 22. In the manner, a desired optical element covering member 2 may be obtained.

In the first embodiment, the cover material 22 contains block copolymer of vinyl aromatic hydrocarbon and conjugate diene, and a mass ratio of vinyl aromatic hydrocarbon to conjugate diene is 95:5 to 5:95. Light from the illuminating device 1 may be utilized effectively.

### (2) Second Embodiment

In the second embodiment, some or all of one or more optical elements 24 in the first embodiment are disposed outside the optical element covering member 2. The optical element 24 disposed outside the optical element covering member 2 is disposed between the optical element covering member 2 and liquid crystal panel 3 and/or between the optical element covering member 2 and the illuminating device 1. The optical element 24 disposed outside the optical element covering member 2 may be bonded, for example, to the transmission surface or incident surface of the optical element covering member with adhesive or the like. The optical element 24 disposed outside the optical element covering member 2 may be an optical diffusion element, an optical convergence element, a reflection type polarizer, a polarizer, an optical division element and the like.

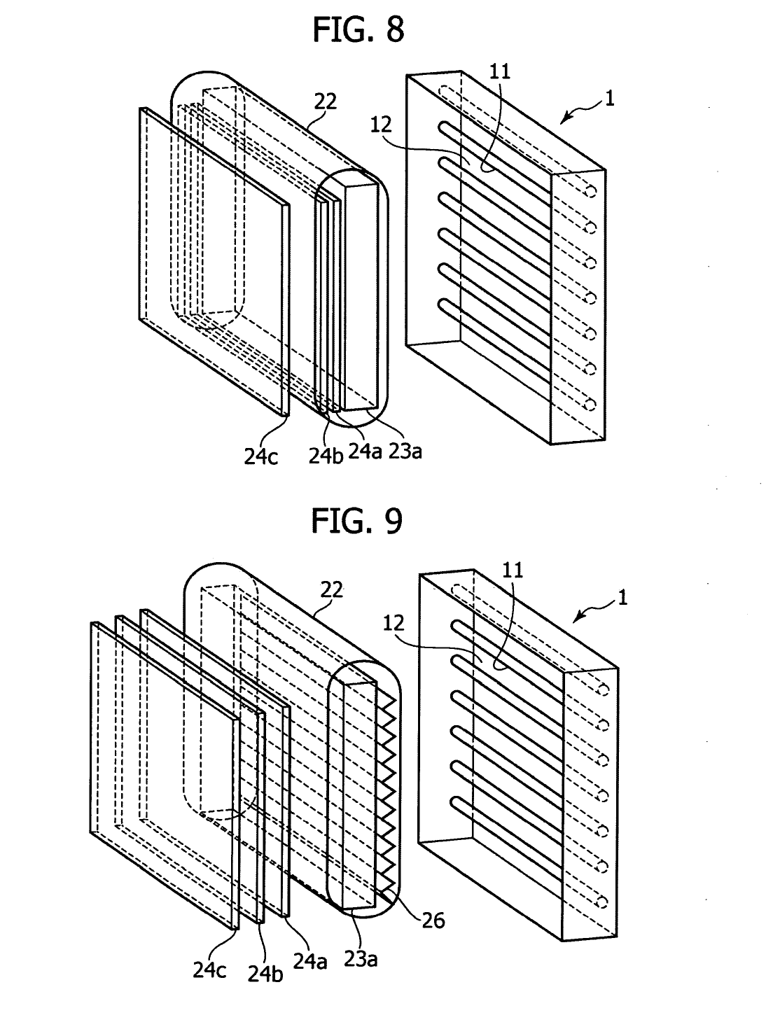

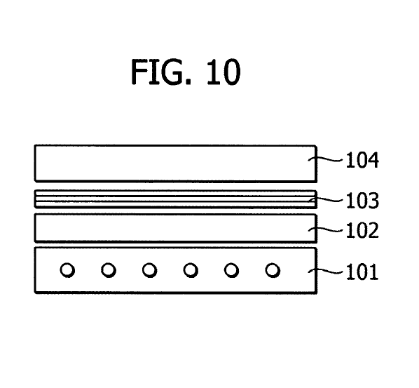

FIG. 8 shows an example of the structure of a backlight according to the second embodiment. As shown in FIG. 8, for example, the optical element covering member 2 and a reflection type polarizer 24c being optical element are disposed in this order from the side of the illuminating device 1 to the side of the liquid crystal panel 3. The optical element covering member 2 has a diffusion plate 23a, a diffusion film 24a and a lens film 24b integrally covered with the cover material 22.

In the second embodiment, since the optical elements 24 such as the reflection type polarizer 24c are disposed outside the optical element covering member 2, light output from the optical elements 24 such as the reflection type polarizer 24c can be made incident upon the liquid crystal panel 3, without changing light polarization.

### (3) Third Embodiment

In the third embodiment, a surface structured member and an optical functional layer are disposed on at least one of the inner surface and outer surface of the cover material 22 of the first embodiment. For example, the optical functional layer is disposed on at least one of the incident surface side and transmission surface side of the optical element covering member 2. The surface structured member and optical functional layer are used for improving the characteristics of light inputted from the illuminating device 1. Various lenses, such as a cylindrical lens, a prism lens, and a fly eye lens may be used as the surface structured member. A wobble may be added on the surface structured member such as the cylindrical lens and prism lens. The surface structured member is formed, for example, by a melt extrusion method or a thermal transfer method. The optical functional layer may be an ultraviolet ray cut functional layer (UV cut functional layer), an infrared ray cut functional layer (IR cut functional layer) and the like.

FIG. 9 shows an example of the structure of a back light of the third embodiment in the present application. As shown in FIG. 9, for example, a diffusion plate 23a, a diffusion film 24a, a lens film 24b, a reflection type polarizer 24c are disposed in this order from the side of the illuminating device 1 to the side of the liquid crystal panel 3. The diffusion plate 23a is covered with the cover material 22, and a surface structured member 26 having a brightness-irregularity-reducing function or the like is mounted to the input side on the inner surface of the cover material 22.

In the third embodiment, since the surface structured member and optical functional layer are disposed on at least one of the inner and outer surfaces of the cover material 22, it is possible to reduce the number of optical elements covered by the cover material 22. It is therefore possible to further thin the optical element covering member 2 and the liquid crystal display apparatus.

### EXAMPLES

The present application will be described in greater detail with reference to the examples, but should not be construed as limited to these examples.

### First Example

### Manufacture Process of Cover Material

Resin of block copolymer (hereinafter this polymer is called a1 for the convenience) made of styrene of 80 mass % and a butadiene of 20 mass % as monomer was melted in an extruder, a tubular non-drawn film was extruded from a ring die, drawn about 1.2 times both in vertical and horizontal directions by a tubular method, and cut by a proper length in the extrusion direction. A circumferential length of the obtained tubular film is 1220 mm and a width thereof is 1030 mm. A thickness of the obtained tubular film is 48 μm and a retardation (45°) is 15 nm. A desired cover material was obtained in this manner.

[Manufacture Process of Optical Element Covering Member]

First, the following support medium and optical elements were prepared.

Support Medium:

Diffusion plate (manufactured by Asahi Kasei Chemicals Corporation, product name: DSE60), size 590 mm×1015 mm, thickness 2 mm

Optical Elements:

Diffusion sheet (manufactured by Tsujiden Co., Ltd, product name: D121SIII), size 590 mm×1015 mm, thickness 68 μm

Prism sheet (manufactured by Sumitomo 3M Limited, product name BEFIII), size 590 mm×1015 mm, thickness 155 μm

Reflection type polarizer sheet (manufactured by Sumitomo 3M Limited, product name DBEF), size 590 mm×1015 mm, thickness 400 μm

Next, the diffusion plate, diffusion sheet, prism sheet and reflection type polarizer sheet were laminated in this order to obtain a lamination. Next, the lamination was inserted into the tubular film manufactured in the manner described above from its opening end. Next, the lamination covered with the tubular film was transported to a constant temperature oven at a temperature of 90° C. and kept in the oven for 120 seconds to thermally shrink the cover material and obtain tight adhesion with the optical elements. A desired optical element covering member was obtained in this manner.

### Second Example

A optical element covering member was obtained in the manner similar to the first example, except that block copolymer (hereinafter this polymer is called a2 for the convenience) made of styrene of 95 mass % and butadiene of 5 mass % as monomer was used as resin of the cover material. A thickness of the obtained film was 50 μm and a retardation (45°) was 25 nm.

### Third Example

A optical element covering member was formed in the manner similar to the first example, except that block copolymer (hereinafter this polymer is called a3 for the convenience) made of styrene of 5 mass % and butadiene of 95 mass % as monomer was used as resin of the cover material. A thickness of a film was 52 μm and a retardation (45°) was 20 nm.

### Fourth Example

Blend material mixing a1 and polystyrene (hereinafter this polymer is called b1 for the convenience) made of styrene as monomer was used as resin of the cover material. A mass ratio (a1:b1) of a1 to b1 was 80:20. A optical element covering member was obtained by the other conditions similar to those of the first example. A thickness of a film of the obtained cover material was 50 μm and a retardation (45°) was 10 nm.

### Fifth Example

Blend material mixing a1 and HIPS (hereinafter this polymer is called b2 for the convenience) made of styrene of 90 mass % and butadiene of 10 mass % as monomer was used as resin of the cover material. A mass ratio (a1:b2) of a1 to b2 was 80:20. A optical element covering member was obtained by the other conditions similar to those of the first example. A thickness of a film of the obtained cover material was 48 μm and a retardation (45°) was 15 nm.

### Sixth Example

Blend material mixing a1 and styrene-methacrylic acid copolymer (hereinafter this polymer is called b3 for the convenience) made of styrene of 80 mass % and methacrylic acid of 20 mass % as monomer was used as resin of the cover material. A mass ratio (a1:b3) of a1 to b3 was 80:20. A optical element covering member was obtained by the other conditions similar to those of the first example. A thickness of a film of the obtained cover material was 52 μm and a retardation (45°) was 20 nm.

### Seventh Example

Blend material mixing a1 and styrene-butylacrylate copolymer (hereinafter this polymer is called b4 for the convenience) made of styrene of 80 mass % and butylacrylate of 20 mass % as monomer was used as resin of the cover material. A mass ratio (a1:b4) of a1 to b4 was 80:20. A optical element covering member was obtained by the other conditions similar with those of the first example. A thickness of a film of the obtained cover material was 48 μm and a retardation (45°) was 20 nm.

### Eighth Example

Block polymer of a1 was used as resin of the cover material and the polymer was melted by an extruder, a film was extruded from a T die, drawn about 2 times both in vertical and horizontal directions by a tenter method, and cut by a proper length in the extrusion direction. Opposite ends of an obtained strip film in the longitudinal direction were bonded to form a tubular film having a circumferential length of 1250 mm and a width of 1100 mm. A thickness of the obtained tubular film was 30 μm and a retardation (45°) was 15 nm. A optical element covering member was obtained by the other conditions similar to those of the first example.

### Ninth Example

Co-extrusion two-type three-layer inflation extruders were used, a1 polymer and b1 polymer were used as outer layer resin and inner layer resin, respectively, and melted in each extruder to extrude a three-layer film via a ring die, drawn about 1.2 times both in vertical and horizontal directions by a tubular method, and cut by a proper length in the extrusion direction. A circumferential length of an obtained tubular film was 1230 mm and a width thereof was 1040 mm. A thickness of the obtained tubular film was 70 μm, a thickness of each of the outer two layers was 10 μm, and a thickness of the inner layer was 50 μm. A retardation (45°) was 15 nm. A optical element covering member was obtained with the other conditions similar to those of the first example.

### Tenth Example

A optical element covering member was obtained in the manner similar to the ninth example, except that b1 polymer was used as the resin for outer layers and a1 polymer was used as the resin for an inner layer. A thickness of an obtained tubular film was 72 μm, a thickness of each the outer two layers thereof was 10 μm, and a thickness of the inner layer was 52 μm. A retardation (45°) was 15 nm.

### Eleventh Example

A optical element covering member was obtained in the manner similar to the first example, except that a diffusion plate, a diffusion sheet and a prism sheet were laminated in this order as optical elements, without using a reflection type polarizer sheet. A thickness of an obtained tubular film was 48 μm and a retardation (45°) was 15 nm.

The following optical element was prepared as the optical element to be provided between the optical element covering member and liquid crystal display panel.

Optical Element:

Reflection type polarizer sheet (manufactured by Sumitomo 3M Limited, product name DBEF), size 590 mm×1015 mm, thickness 440 μm

### Twelfth Example

A optical element covering member was obtained in the manner similar to the first example, except that a diffusion plate and a diffusion sheet were laminated in this order as optical elements, without using a reflection type polarizer sheet and a prism sheet. A thickness of an obtained tubular film was 48 μm and a retardation (45°) was 15 nm.

The following optical elements were prepared as the optical elements disposed between the optical element covering member and liquid crystal display panel.

Optical Elements:

Prism sheet (manufactured by Sumitomo 3M Limited, product name BEFIII), size 590 mm×1015 mm, thickness 275 μm

Reflection type polarizer sheet (manufactured by Sumitomo 3M Limited, product name DBEF), size 590 mm×1015 mm, thickness 440 μm

### First Comparative Example

### Manufacture Process for Optical Element Lamination

First, the following support medium and optical elements were prepared.

Support Medium:

Diffusion plate (manufactured by Asahi Kasei Chemicals Corporation, product name: DSE60), size 590 mm×1015 mm, thickness 2 mm

Optical Elements:

Diffusion sheet (manufactured by Tsujiden Co., Ltd, product name: D121UZ), size 590 mm×1015 mm, thickness 218 μm

Prism sheet (manufactured by Sumitomo 3M Limited, product name BEFIII), size 590 mm×1015 mm, thickness 275 μm

Reflection type polarizer sheet (manufactured by Sumitomo 3M Limited, product name DBEF), size 590 mm×1015 mm, thickness 440 μm

Next, the diffusion plate, diffusion sheet, prism sheet and reflection type polarizer sheet were laminated in this order to obtain a desired optical element lamination.

### Second Comparative Example

An optical element lamination was obtained in the manner similar to the first comparative example, except that the following optical elements were used.

Optical Elements:

Diffusion sheet (manufactured by Tsujiden Co., Ltd, product name: D121SIII), size 590 mm×1015 mm, thickness 68 μm

Prism sheet (manufactured by Sumitomo 3M Limited, product name BEFIII), size 590 mm×1015 mm, thickness 155 μm

Reflection type polarizer sheet (manufactured by Sumitomo 3M Limited, product name DBEF), size 590 mm×1015 mm, thickness 400 μm

### Third Comparative Example

A optical element covering member was obtained in the manner similar to the first example, except that block copolymer (hereinafter this polymer is called a4 for the convenience) made of styrene of 98 mass % and butadiene of 2 mass % as monomer was used as resin of the cover material. A thickness of a film of the obtained cover material was 48 μm and a retardation (45°) was 25 nm.

### Fourth Comparative Example

A optical element covering member was obtained in the manner similar to the first example, except that block copolymer (hereinafter this polymer is called a5 for the convenience) made of styrene of 2 mass % and butadiene of 98 mass % as monomer was used as resin of the cover material. A thickness of a film of the obtained cover material was 50 μm and a retardation (45°) was 35 nm.

### Fifth Comparative Example

A optical element covering member was obtained in the manner similar to the first example, except that random copolymer (hereinafter this polymer is called a6 for the convenience) made of styrene of 80 mass % and butadiene of 20 mass % as monomer was used as resin of the cover material. A thickness of a film of the obtained cover material was 52 μm and a retardation (45°) was 35 nm.

### Sixth Comparative Example

A optical element covering member was obtained in the manner similar to the first example, except that blend material (hereinafter this material is called a7 for the convenience) was used as resin of the cover material, the blend material being polymer of polystyrene formed of styrene of 100 mass % and butadiene of 100 mass % and having a mass ratio (polystyrene:butadiene) of 80:20. A thickness of a film of the obtained cover material was 48 μm and a retardation (45°) was 40 nm.

### Seventh Comparative Example

A optical element covering member was obtained in the manner similar to the eighth example, except that b1 was used for resin of the cover material. A thickness of a film of the obtained cover material was 32 μm and a retardation (45°) was 25 nm.

### Eighth Comparative Example

A optical element covering member was obtained in the manner similar to the eighth example, except that polypropylene was used for resin of the cover material. A thickness of a film of the obtained cover material was 30 μm and a retardation (45°) was 35 nm.

### Ninth Comparative Example

A optical element covering member was obtained in the manner similar to the first example, except that amorphous-polyethyrene terephthalate (A-PET) was used for resin of the cover material. A thickness of a film of the obtained cover material was 50 μm and a retardation (45°) was 55 nm.

### Tenth Comparative Example

A optical element covering member was obtained in the manner similar to the eighth example, except that polyethyrene was used as resin of the cover material. A thickness of a film of the obtained cover material was 32 μm and a retardation (45°) was 35 nm.

The following Table 1 shows the structures of a1 to a7 resin materials used in the examples and comparative examples, and the following Table 2 shows the structures of b1 to b4 resin materials used in the examples and comparative examples.

TABLE 1

| | | Ratio per monomer | Polymerization |
|---|---|---|---|
| Resin Material | Monomer | unit (mass %) | state |
| a1 | Styrene | 80 | Block copolymer |
| | Butadiene | 20 | |
| a2 | Styrene | 95 | Block copolymer |
| | Butadiene | 5 | |
| a3 | Styrene | 5 | Block copolymer |
| | Butadiene | 95 | |
| a4 | Styrene | 98 | Block copolymer |
| | Butadiene | 2 | |
| a5 | Styrene | 2 | Block copolymer |
| | Butadiene | 98 | |
| a6 | Styrene | 80 | Random |
| | Butadiene | 20 | copolymer |
| a7 | Styrene | 100 | Blend |

TABLE 2

| | | Ratio per monomer | Polymerization |
|---|---|---|---|
| Resin Material | Monomer | unit (mass %) | state |
| b1 | Styrene | 100 | Polystyrene |
| b2 | Styrene | 90 | HIPS |
| | Butadiene | 10 | |
| b3 | Styrene | 80 | Styrene- |
| | Methacrylic | 20 | methacrylic acid |
| | acid | | copolymer |
| b4 | Styrene | 80 | Styrene- |
| | | | butylacrylate |
| | Butylacrylate | 20 | copolymer |

HIPS: high impact rubber denatured styrene resin

Thicknesses of the film (cover material), optical element lamination and optical element covering member of the examples were measured with an average of measurement values of each measurement object at central five points by using an outside micrometer (manufactured by TESA TECHNOLOGY LTD).

The retardation of the cover material was measured with a rotating analyzer method by using an optical material inspection apparatus (manufactured by OTSUKA ELECTRONICS CO., LTD, RETS-100).

[Evaluation]

KDL-46V2000 (46-type liquid crystal television manufactured by Sony Corporation) was prepared as a large size liquid crystal television evaluation machine. The diffusion plate, diffusion sheet, prism sheet and reflection type polarizer sheet as the optical elements of a backlight unit in the liquid crystal television were removed, and the optical element covering members of the first to eighth examples and third to tenth comparative examples or the optical element laminations of the first and second comparative examples were remounted. In the eleventh example, the reflection type polarizer sheet was disposed between the optical element covering member and liquid crystal display panel. In the twelfth example, the prism sheet, reflection type polarizer sheet were disposed in this order from the optical element covering member side, between the optical element covering member and liquid crystal display panel.

An on-axis luminance, luminance irregularity and heat resistance were each evaluated for the first to twelfth examples and first to tenth comparative examples.

<Evaluation of On-Axis Luminance>

A white display video signal was input to the liquid crystal display apparatus mounting each of the optical element covering members of the first to tenth examples and the third to tenth comparative examples, each of the optical element laminations of the first and second comparative examples, or each of the optical element covering members and each of the optical elements of the eleventh and twelfth examples, and the liquid crystal display apparatus was lighted up for two hours in a dark room, and thereafter, a luminance was measured by setting a spectral emittance luminous meter (manufactured by Konica Minolta Holdings, Inc., CS-100) at a place 500 mm distant from the panel surface of the liquid crystal display apparatus. An on-axis luminance of the liquid crystal television in a standard setting state used for evaluation was adjusted to 510 nit, and evaluated based on the following standards.

Circle symbol: 500 nit or more

Triangle symbol: 480 to 599 nit

Cross symbol: less than 480 nit

<Evaluation of Luminance Irregularity and Heat Resistance>

A white display video signal was inputted to the liquid crystal display apparatus mounting the optical element covering members of the first to tenth examples and the third to tenth comparative examples, the optical element laminations of the first and second comparative examples, or the optical element covering members and the optical elements of the eleventh and twelfth examples, and lighted up for eight hours in a constant temperature oven at a temperature of 45° C. and a humidity of 60° C. Thereafter, a luminance irregularity was visually evaluated based on the following criterion from a position spaced by 1 m in a direction inclined by about 45° from the panel front surface of the liquid crystal display apparatus. A temperature in the television set was 75° C.

Circle symbol: no irregularity

Triangle symbol: slight irregularity

Cross symbol: definite irregularity confirmed

Evaluation results are shown in the following Table 3. The total thickness of the optical element covering member shown in Table 3 means a sum of a thickness of the optical element covering member and a thickness of the optical elements disposed outside the optical element covering member in the eleventh and twelfth example, and means a total thickness of the optical element lamination of the first and second comparative examples. Indication of “(Thick)” in the optical element structure means that an optical element is used in a related art large size liquid crystal display television, and thicker than an optical element not given “(Thick)” indication.

| | | | | | | COVER |
|---|---|---|---|---|---|---|
| | | | | | | STRUCTURE |
| | | | | COVER | | OF OPTICAL |
| | | | FILM | RETAR- | COVER | ELEMENT |
| | COVER | FILM | MANUFACTURE | DATION | THICKNESS | TOTAL |
| | MATERIAL | LAYER | METHOD | [nm] | [μm] | THICKNESS |
| EXAMPLE 1 | a1 | SINGLE | INFLATION | 15 | 48 | ABOUT 2720 |
| | | LAYER | METHOD | | | |
| EXAMPLE 2 | a2 | SINGLE | INFLATION | 20 | 50 | ABOUT 2720 |
| | | LAYER | METHOD | | | |
| EXAMPLE 3 | a3 | SINGLE | INFLATION | 20 | 52 | ABOUT 2720 |
| | | LAYER | METHOD | | | |
| EXAMPLE 4 | a1 + b1 | SINGLE | INFLATION | 10 | 50 | ABOUT 2720 |
| | | LAYER | METHOD | | | |
| EXAMPLE 5 | a1 + b2 | SINGLE | INFLATION | 15 | 48 | ABOUT 2720 |
| | | LAYER | METHOD | | | |
| EXAMPLE 6 | a1 + b3 | SINGLE | INFLATION | 20 | 52 | ABOUT 2720 |
| | | LAYER | METHOD | | | |
| EXAMPLE 7 | a1 + b4 | SINGLE | INFLATION | 20 | 48 | ABOUT 2720 |
| | | LAYER | METHOD | | | |
| EXAMPLE 8 | a1 | SINGLE | TENTER | 15 | 30 | ABOUT 2700 |
| | | LAYER | METHOD | | | |
| EXAMPLE 9 | OUTER | TWO- | INFLATION | 15 | 70 | ABOUT 2740 |
| | LAYER: | TYPE | METHOD | | | |
| | a1 | THREE- | | | | |
| | INNER | LAYER | | | | |
| | LAYER: | | | | | |
| | b1 | | | | | |
| EXAMPLE 10 | OUTER | TWO- | INFLATION | 15 | 72 | ABOUT 2740 |
| | LAYER: | TYPE | METHOD | | | |
| | b1 | THREE- | | | | |
| | INNER | LAYER | | | | |
| | LAYER: | | | | | |
| | a1 | | | | | |
| EXAMPLE 11 | a1 | SINGLE | INFLATION | 15 | 48 | ABOUT 2720 |
| | | LAYER | METHOD | | | |
| EXAMPLE 12 | a1 | SINGLE | INFLATION | 15 | 48 | ABOUT 2880 |
| | | LAYER | METHOD | | | |
| COMPARATIVE | NONE | NONE | NONE | NONE | NONE | ABOUT 2960 |
| EXAMPLE 1 | | | | | | |
| COMPARATIVE | NONE | NONE | NONE | NONE | NONE | ABOUT 2650 |
| EXAMPLE 2 | | | | | | |
| COMPARATIVE | a4 | SINGLE | INFLATION | 25 | 48 | ABOUT 2720 |
| EXAMPLE 3 | | LAYER | METHOD | | | |
| COMPARATIVE | a5 | SINGLE | INFLATION | 35 | 50 | ABOUT 2720 |
| EXAMPLE 4 | | LAYER | METHOD | | | |
| COMPARATIVE | a6 | SINGLE | INFLATION | 35 | 52 | ABOUT 2720 |
| EXAMPLE 5 | | LAYER | METHOD | | | |
| COMPARATIVE | a7 | SINGLE | INFLATION | 40 | 48 | ABOUT 2720 |
| EXAMPLE 6 | | LAYER | METHOD | | | |
| COMPARATIVE | b1 | SINGLE | TENTER | 25 | 32 | ABOUT 2700 |
| EXAMPLE 7 | | LAYER | METHOD | | | |
| COMPARATIVE | PP | SINGLE | TENTER | 35 | 30 | ABOUT 2700 |
| EXAMPLE 8 | | LAYER | METHOD | | | |
| COMPARATIVE | A-PET | SINGLE | INFLATION | 55 | 50 | ABOUT 2720 |
| EXAMPLE 9 | | LAYER | METHOD | | | |
| COMPARATIVE | PE | SINGLE | TENTER | 35 | 32 | ABOUT 2700 |
| EXAMPLE 10 | | LAYER | METHOD | | | |

| | CONFIGURATION | CONFIGURATION | | |
|---|---|---|---|---|
| | OF COVERED | OF OPTICAL | | |
| | OPTICAL | ELEMENT | FRONT | IRREGULAR |
| | ELEMENT | OUTSIDE COVER | LUMINANCE | LUMINANCE |
| EXAMPLE 1 | DS/BEF/DBEF | NONE | ∘ | ∘ |
| EXAMPLE 2 | DS/BEF/DBEF | NONE | ∘ | ∘ |
| EXAMPLE 3 | DS/BEF/DBEF | NONE | Δ | ∘ |
| EXAMPLE 4 | DS/BEF/DBEF | NONE | ∘ | ∘ |
| EXAMPLE 5 | DS/BEF/DBEF | NONE | ∘ | ∘ |
| EXAMPLE 6 | DS/BEF/DBEF | NONE | ∘ | ∘ |
| EXAMPLE 7 | DS/BEF/DBEF | NONE | ∘ | ∘ |
| EXAMPLE 8 | DS/BEF/DBEF | NONE | ∘ | ∘ |
| EXAMPLE 9 | DS/BEF/DBEF | NONE | ∘ | ∘ |
| EXAMPLE 10 | DS/BEF/DBEF | NONE | ∘ | ∘ |
| EXAMPLE 11 | DS/BEF | DBEF (THICK) | ∘ | ∘ |
| EXAMPLE 12 | DS | BEF/DBEF | ∘ | ∘ |
| | | (THICK) | | |
| COMPARATIVE | NONE | DS/BEF/DBEF | ∘ | ∘ |
| EXAMPLE 1 | | (THICK) | | |
| COMPARATIVE | NONE | DS/BEF/DBEF | ∘ | x |
| EXAMPLE 2 | | | | |
| COMPARATIVE | DS/BEF/DBEF | NONE | ∘ | x |
| EXAMPLE 3 | | | | |
| COMPARATIVE | DS/BEF/DBEF | NONE | x | ∘ |
| EXAMPLE 4 | | | | |
| COMPARATIVE | DS/BEF/DBEF | NONE | x | Δ |
| EXAMPLE 5 | | | | |
| COMPARATIVE | DS/BEF/DBEF | NONE | x | Δ |
| EXAMPLE 6 | | | | |
| COMPARATIVE | DS/BEF/DBEF | NONE | ∘ | x |
| EXAMPLE 7 | | | | |
| COMPARATIVE | DS/BEF/DBEF | NONE | Δ | x |
| EXAMPLE 8 | | | | |
| COMPARATIVE | DS/BEF/DBEF | NONE | x | Δ |
| EXAMPLE 9 | | | | |
| COMPARATIVE | DS/BEF/DBEF | NONE | x | Δ |
| EXAMPLE 10 | | | | |

PP: POLYPROPYLENE,
PE: POLYETHYLENE,
A-PET: AMORPHOUS POLYETHYLENE TEREPHTHALATEDS: DIFFUSION SHEET,
DEF: PRISM SHEET,
DBEF: REFLECTION TYPE POLARIZER SHEET

In the first to tenth examples, each of the optical element covered by the optical element lamination are thinner than an optical element used in a related art large size television used in the first comparative example. Therefore, the optical element laminations of the first to tenth examples are thinner than the optical element lamination of the first comparative example. Therefore, even though a thickness of the cover material is added, a total thickness of the optical element covering member of first to tenth examples is thinner than that of the first comparative example. The cover material of the first to tenth examples had sufficient tight adhesion to the optical elements so that rigidity, transparency and heat resistance was not degraded. Therefore, a luminance and a luminance irregularity with heat resistance were superior to those of the first comparative example. In the second comparative example, where the optical elements not covered with the cover material and having thickness similar to that of the first to tenth examples are used, although a luminance had no practical problem, there was a luminance irregularity. Since the optical element laminations of the first and second comparative examples were not covered with the optical member, air was entered between the optical elements, and a thickness of each optical element lamination was thicker than a total thickness of each of the optical element.

In the first and eighth examples, polymer of vinyl aromatic hydrocarbon and conjugate diene was used as the material of the cover. It has been found that favorable results are obtained regarding both an on-axis luminance and luminance irregularity. In the seventh to tenth comparative examples in which material that has been typically used as the cover material is employed, a retardation is large, a luminance is lowered, and luminance irregularity due to deflection is caused. Therefore, good results were not obtained for both an on-axis luminance and a luminance irregularity.

As is evident by comparing the first to third examples and the third and fourth comparative examples, polymer of vinyl aromatic hydrocarbon and conjugate diene having a mass ratio of 95:5 to 5:95 was used as the material of the cover to obtain good results in both of an on-axis luminance and luminance irregularity. A film was slightly whitish and a luminance was lowered in the fifth comparative example using random copolymer and in the sixth comparative example using blend material of styrene polymer and butadiene polymer.

Good results were obtained for an on-axis luminance and luminance irregularity in the fourth to seventh examples even though the blend material of block polymer of vinyl aromatic hydrocarbon and conjugate diene and vinyl aromatic hydrocarbon polymer were used as a cover material. It has been found from the ninth and tenth examples that if a multilayer cover has at least one layer made of block polymer of vinyl aromatic hydrocarbon and conjugate diene, degradation of optical characteristics by the cover material can be suppressed.

In the eleventh and twelfth examples, good results were obtained for both a luminance and luminance irregularity, when an optical element is disposed between the optical element covering member and the liquid crystal display panel.

Embodiments of the present application have been described. The present application is not limited to the embodiments, but various modifications based on the technical concept of the present application are possible.

For example, numerical values used in the embodiments are only illustrative, and different numerical values may be used when necessary.

The structures of the embodiments may be combined as long as the gist is not deviated.

In an embodiment, the optical elements or the optical element and support medium may be bonded partially so that the optical functions are not degraded, this bonding is preferably made in a end portion so as not to degrade the display function.

Further, in an embodiment, the optical element covering member may be provided with a brightness-irregularity-reducing film. This brightness-irregularity-reducing film is disposed, for example, between the incident surface of the support medium and the cover material.

In the embodiments, a film or sheet type material is used for cover, but alternatively, a case having a rigidity to some degree may be used as the cover material.

Thus, according to embodiment, it is possible to improve insufficient rigidity of the optical elements while suppressing an increase in the thickness of the liquid crystal display device or a degradation of display characteristics of the liquid crystal display device. Further, it is also possible to suppress a degradation of optical characteristics by the cover material.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A optical element covering member comprising:
one or more optical elements;
a support medium for supporting the one or more optical elements; and
a cover material for covering the one or more optical elements and the support medium,
wherein:
the cover material includes a layer of block copolymer of vinyl aromatic hydrocarbon and conjugate diene; and
a mass ratio of the vinyl aromatic hydrocarbon to the conjugate diene stands at 95:5 to 5:95.

2. The optical element covering member according to claim 1, wherein the cover material is made of a single layer or a plurality of layers.

3. The optical element covering member according to claim 1, wherein the cover material further includes at least one kind of vinyl aromatic hydrocarbon polymer selected from a group consisting of:
vinyl aromatic hydrocarbon polymer,
copolymer of vinyl aromatic hydrocarbon and (meta) acrylic acid,
copolymer of vinyl aromatic hydrocarbon and (meta) acrylic acid ester, and
rubber denatured styrene polymer.

4. The optical element covering member according to claim 1, wherein the block copolymer is styrene-butadiene block copolymer.

5. The optical element covering member according to claim 3, wherein the vinyl aromatic hydrocarbon polymer is at least one type of polymer selected from a group including polystyrene, high impact rubber denaturated styrene resin, styrene-metaacrylic acid copolymer, styrene-n butylacrylate copolymer, and styrene-n butylacrylate-methylmetaacrylate copolymer.

6. The optical element covering member according to claim 1, further comprising:
an incident surface on which light becomes incident from a light source;
an transmission surface for outputting light incident upon the incident surface to a liquid crystal panel; and
end planes provided between the input and transmission surfaces,
wherein opposite end portions of the cover material are superimposed and bonded together on the end planes in conformity with the end planes.

7. The optical element covering member according to claim 1, wherein;
the cover material has an open-ended tubular shape, and
opposite end portions of the open-ended tubular shaped cover material are opened.

8. The optical element covering member according to claim 1, wherein;
the cover material has an open-ended tubular shape, and
the optical element covering member is formed by inserting the support medium and the optical elements from opened opposite end portions of the open-ended tubular shaped cover material.

9. The optical element covering member according to claim 1, wherein;
the cover material has a strip shape, and
end portions of the strip shaped cover material in the longitudinal direction are bonded.

10. A backlight comprising:
a light source for emitting light; and
an optical element covering member for improving characteristics of light emitted from the light source and outputting light to a liquid crystal panel, wherein;
the optical element covering member includes:
one or more optical elements;
a support medium for supporting the one or more optical elements; and
a cover material for covering the one or more optical elements and the support medium, wherein;
the cover material includes a layer of block copolymer of vinyl aromatic hydrocarbon and conjugate diene; and
a mass ratio of the vinyl aromatic hydrocarbon to the conjugate diene stands at 95:5 to 5:95.

11. A liquid crystal display device comprising:
a light source for emitting light; and
an optical element covering member for improving characteristics of light emitted from the light source and outputting light to a liquid crystal panel, wherein;
the optical element covering member includes;
one or more optical elements;
a support medium for supporting the one or more optical elements; and
a cover material for covering the one or more optical elements and the support medium, wherein:
the cover material includes a layer of block copolymer of vinyl aromatic hydrocarbon and conjugate diene; and
a mass ratio of the vinyl aromatic hydrocarbon to the conjugate diene stands at 95:5 to 5:95.
